(19) United States
(12) Patent Application Publication
(10) Pub. No.: US 2006/0291673 A1
(43) Pub. Date: Dec. 28, 2006

(54) Speaker

(76) Inventors: Hideo Kitazawa, Nagano (JP); Akinori Ushikoshi, Nagano (JP); Takamasa Kaneko, Shizuoka (JP); Kenji Yokoyama, Tokyo (JP)

Correspondence Address: CANTOR COLBURN, LLP, 55 GRIFFIN ROAD SOUTH, BLOOMFIELD, CT, 06002, US

(21) Appl. No.: 11/447,325

(22) Filed: Jun. 6, 2006

(30) Foreign Application Priority Data
Jun. 7, 2005 (JP) 2005-167528

(51) Int. Cl. H04R 3/00

(52) U.S. Cl. 381/117

(57) ABSTRACT

A speaker may include a center pole, a voice coil bobbin, a support member that supports at least one of the center pole and the voice coil bobbin, and a converter circuit for converting an electrostatic capacity which is formed between the center pole and the voice coil bobbin into an electric signal to be outputted. The converter circuit is provided on either of the support member and the center pole and may be disposed at the tip end of the center pole. Alternatively, the converter circuit may be provided on a diaphragm

### CROSS REFERENCE TO RELATED APPLICATION

The present invention claims priority under 35 U.S.C. §119 to Japanese Application No. 2005-167528 filed Jun. 7, 2005, which is incorporated herein by reference.

1. Field of the Invention

An embodiment of the present invention may relate to a speaker. More specifically, an embodiment of the present invention may relate to a speaker that detects an operating state of the diaphragm of the speaker.

2. Background of the Invention

In some audio speakers, a Motion Feed Back (“MFB”) circuit is included as a technique to improve the sound quality of the speaker. The MFB circuit detects the operating state of a vibrating diaphragm through an electrical signal conveying audio information (hereinafter referred to as an “audio signal”) that is inputted to a speaker. The MFB circuit controls the diaphragm based on the detection result. In this manner, the distortion of sound that is especially likely to occur in a low tone region can be canceled. Therefore, it is sometimes mistakenly assumed that the MFB circuit is commonly effective to be utilized in a small-sized speaker with which reproduction in a low tone region is difficult.

For example, the following five references with regard to the MFB circuit are known; Japanese Patent Laid-Open No. Sho 52-79644, Japanese Patent Laid-Open No. Sho 53-12319, Japanese Patent Laid-Open No. Sho 53-12320, Japanese Patent Laid-Open No. Sho 53-12321, and Japanese Utility Model Laid-Open No. Sho 57-96589. In these references, the operating state of the diaphragm is detected by detecting the variation of an electrostatic capacity formed between electrodes. More specifically, an electrode (hereinafter, referred to as “movable electrode”) is fixed to a diaphragm or to an electromagnetic coil which is referred to as a voice coil bobbin that causes the diaphragm to vibrate, and another electrode (hereinafter, referred to as “fixed electrode”) is fixed so as to face the movable electrode. An electrostatic capacity, which is varied by the movable electrode moving relative to the fixed electrode, is detected by a detector and is converted into an electrical signal (hereinafter, referred to as “detection signal”) by a converter circuit to be outputted. After that, the detection signal and the audio signal are compared with each other by a comparison device (a CPU, for example), and then the operation of the diaphragm is appropriately controlled on the basis of the compared result, i.e., the difference between the output level of the detection signal and the output level of the audio signal.

However, in the conventional speaker, a converter circuit is mounted in an amplifier which is installed at a remote position from a detector and thus long lead wires connecting the respective electrodes with the converter circuit are required. Therefore, an electric current flowing through the lead wire is affected by static electricity, which is caused by various electromagnetic phenomena in the inside or the outside of the speaker, electromagnetic waves which is outputted from electronic equipment installed around the speaker, or the like (hereinafter, referred to as “disturbance noise”). As a result, in the conventional speaker, there is a problem that a true electrostatic capacity formed between the electrodes cannot be converted to a detection signal in the converter circuit. Accordingly, in the prior art, the operating state of the diaphragm cannot be accurately detected and the distortion of a sound in a low tone region in a particularly small speaker cannot be sufficiently eliminated.

### BRIEF DESCRIPTION OF THE INVENTION

In view of the problems described above, an embodiment of the present invention may advantageously provide a speaker which is capable of accurately detecting an electrostatic capacity formed between electrodes without being affected by disturbance noise.

Thus, according to an embodiment of the present invention, there may be provided a speaker comprising a center pole, a voice coil bobbin, a support member that supports at least one of the center pole and the voice coil bobbin, and a converter circuit for converting an electrostatic capacity which is formed between the center pole and the voice coil bobbin into an electric signal to be outputted. The converter circuit is provided in either the support member or the center pole.

Therefore, in the speaker in accordance with an embodiment, a distance from a position where an electrostatic capacity is detected to a converter circuit is shortened and thus a lead wire connecting the position where the electrostatic capacity is detected to the converter circuit can be shortened. Accordingly, effect of disturbance noise on an electric current which flows in a lead wire can be suppressed and a minute electrostatic capacity which is formed between the center pole and the voice coil bobbin can be accurately inputted into the converter circuit. Therefore, the converter circuit is capable of outputting the electrostatic capacity as an accurate electric signal and thus, for example, the electric signal is effectively utilized in the MFB circuit and sound distortion from a speaker, especially a small speaker, which is a conventional problem can be reduced. Therefore, a low tone range similar to one in a large speaker can be realized even in a small speaker.

In a speaker in accordance with an embodiment, a converter circuit is disposed at the tip end of the center pole. In this case, the distance from the position where an electrostatic capacity is detected to the converter circuit is further shortened and thus the lead wire connecting the position where the electrostatic capacity is detected to the converter circuit can be shortened. According to the structure described above, the effect of disturbance noise on an electric current which flows in the lead wire can be further suppressed, and a minute electrostatic capacity which is formed between the center pole and the voice coil bobbin can be further accurately inputted into the converter circuit.

Further, in a speaker in accordance with an embodiment, the voice coil bobbin is structured with a nonmetallic pipe body as its base and a nonmagnetic electric conductor film is formed on the outer peripheral face of the pipe body. In this case, since disturbance noise can be prevented by the electric conductor film, the converter circuit attached on the tip end of the center pole and a lead wire connecting a position where the electrostatic capacity is detected and the converter circuit are difficult for disturbance noise to effect. Therefore, a minute electrostatic capacity that is formed between the center pole and the voice coil bobbin can be further accurately inputted into the converter circuit. Further, the converter circuit is capable of accurately converting the detected electrostatic capacity into an electric signal. In this case, it is preferable that the voice coil bobbin is structured with a nonmetallic pipe body as a base, that an electric conductor film for forming a capacitor between the center pole and the electric conductor film is formed on an inner side of the pipe body, and that an electrostatic capacity of the capacitor is detected by the converter circuit which is disposed at the tip end of the center pole.

Further, in a speaker in accordance with an embodiment, a nonmagnetic and electric conductor film which is formed on the outer peripheral face of the pipe body is grounded. According to the structure described above, disturbance noise can be prevented by the electric conductor film. For example, when the converter circuit is mounted on the tip end of the center pole, the outer peripheral face of the pipe body functions as a shield for blocking disturbance noise and thus the converter circuit and the lead wire connecting the converter circuit with a portion where the electrostatic capacity is detected are difficult for disturbance noise to affect. Therefore, a minute electrostatic capacity that is formed between the center pole and the voice coil bobbin can be further accurately inputted into the converter circuit. Further, the converter circuit is capable of further accurately converting the detected electrostatic capacity into an electric signal.

Further, in a speaker in accordance with an embodiment, a through-hole is formed from the tip end of the center pole to the base end of the center pole and a lead wire outputting an electric signal, i.e., the output signal of the converter circuit, is passed through the through-hole. In this case, disturbance noise can be prevented by the center pole. According to the structure described above, since the center pole functions as a shield for blocking disturbance noise, the effect of disturbance noise on the lead wire passing through the center pole can be prevented. Therefore, an accurate electric signal can be outputted from the converter circuit to the outside.

Further, in a speaker in accordance with an embodiment, the minus side terminal of the converter circuit is grounded. According to the structure described above, a floating electrostatic capacity in the converter circuit can be suppressed and disturbance noise can be prevented.

Further, according to an embodiment of the present invention, there may be provided a speaker comprising a center pole, a voice coil bobbin, a diaphragm and a converter circuit for converting an electrostatic capacity which is formed between the center pole and the voice coil bobbin into an electric signal to be outputted where the converter circuit is provided in the diaphragm.

According to the speaker described above, a distance from a position where the electrostatic capacity is detected to the converter circuit is shortened and thus a lead wire connecting the position where the electrostatic capacity is detected to the converter circuit can be shortened. Accordingly, effect of disturbance noise to an electric current which flows in a lead wire can be suppressed and a minute electrostatic capacity which is formed between the center pole and the voice coil bobbin can be accurately inputted into the converter circuit.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view showing a structure of a speaker in accordance with an embodiment of the present invention.

FIG. 2 is a functional block diagram showing an electrical structure of a speaker.

FIG. 3 is a circuit diagram showing a structure of a detector and a converter circuit.

FIG. 4 is a cross-sectional view showing parts of a voice coil bobbin, a center pole and a yoke.

### DETAILED DESCRIPTION OF THE PREFERRED EMBODIMENTS

An embodiment of a speaker will be described in detail below with reference to the accompanying drawings.

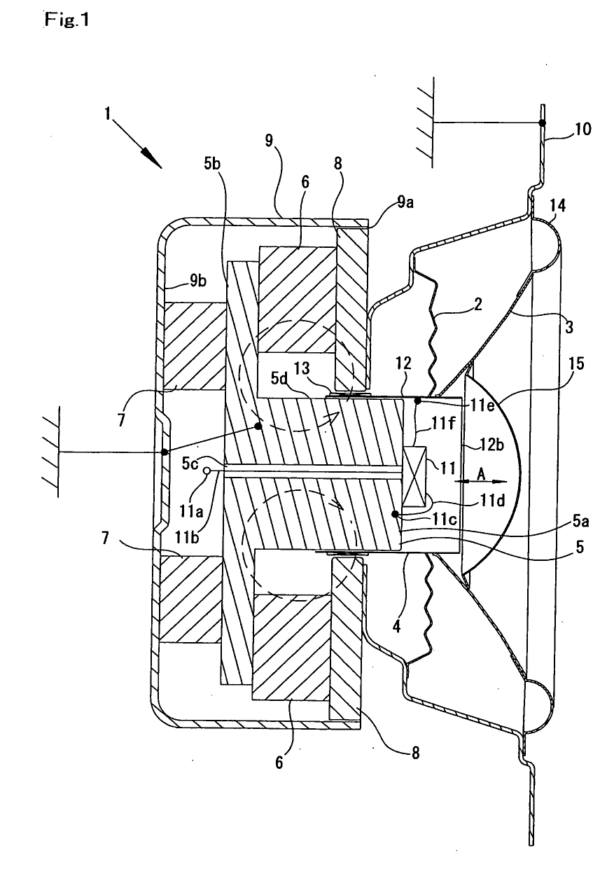

A speaker in accordance with an embodiment is shown in FIGS. 1 through 3. In the speaker 1 in accordance with an embodiment, an electrostatic capacity that is formed between the center pole 5 and the voice coil bobbin 4 is detected. In accordance with an embodiment, a converter circuit 11 with which a detected electrostatic capacity is converted into an electric signal and outputted is mounted on either a case 9, a frame 10 (support member supporting at least either of the center pole and the voice coil bobbin) or the center pole 5.

As shown in FIG. 1, the speaker 1 includes diaphragms 2, 3, the voice coil bobbin 4, the center pole 5, magnets 6, 7, a yoke 8, the case (support member) 9, the frame (support member) 10 and the converter circuit 11. The case 9 is formed in a measured shape. The center pole 5, the magnets 6, 7 and the yoke 8 are accommodated in the case 9 and these are fixed on the inner wall face of the case 9 with an adhesive or a screw.

The center pole 5 is made of iron and includes a cylindrical main body 5a of the center pole S and a disk-shaped flange 5b which is formed at the base end of the main body 5a of the center pole 5. Further, a through-hole 5c is formed at the center portion of the tip end of the center pole 5 and the through-hole 5c penetrates the center pole 5 from its tip end to its base end. The center pole 5 structured as described above is disposed in the case 9 such that the tip end portion of the main body 5a of the center pole 5 is protruded outside of the case 9 from the substantially center portion of the opening 9a of the case 9.

The center pole 5 and the case 9 are connected to a housing (not shown) which is referred to as an enclosure and are grounded. The ring-shaped magnet 6 is magnetically attracted to a face of the flange 5b that faces the opening 9a so as to surround the main body 5a of the center pole 5 as its center. The substantially disk-shaped yoke 8 is magnetically attracted to the face of the magnet 6 that faces the opening 9a and thus the magnet 6 is disposed in a state that the magnet 6 is sandwiched by the yoke 8 and the flange 5b of the center pole 5. The magnet 7 whose shape is the same as the magnet 6 is disposed between the face of the flange 5b that faces the bottom part 9b of the case 9 and the bottom part 9b. The magnet 7 is disposed on the bottom part 9b such that the pole of the magnet 7 on the side abutting with the flange 5b is the same pole of the magnet 6 on the side abutting with the flange 5b. According to the structure described above, a stable magnetic flux loop (described below) is formed between the magnet 7, the yoke 8 and the center pole 5.

The substantially disk-shaped yoke 8 is disposed so as to be substantially perpendicular to the axis in the longitudinal direction of the cylindrical main body 5a of the center pole 5. The yoke 8 is magnetically attracted to the magnet 6 such that the inner peripheral face of the yoke 8 faces the outer peripheral face 5d of the main body 5a of the center pole 5 and an air gap is formed between the inner peripheral face of the yoke 8 and the outer peripheral face 5d. Further, the inner peripheral face of the substantially disk-shaped yoke 8 faces the main body 5a of the center pole 5 within the case 9 and the outer peripheral face of the yoke 8 is disposed to be positioned close to the inner wall face of the case 9.

The voice coil bobbin 4 comprises a tubular shaped bobbin 12 whose front end and rear end are opened and a coil 13 which is wound around the outer periphery of the bobbin 12. An electric conductor such as an enameled wire or a copper wire is used as the coil 13, but another appropriate electric conductor may be used. The bobbin 12 is installed in the case 9 so as to be capable of sliding or moving in a forward and backward direction (direction of the arrow “A” in FIG. 1) and thus the bobbin 12 is capable of vibrating in the forward and backward direction by an exciting operation described below. The inner side diameter of the bobbin 12 is set to be slightly larger than the outer side diameter of the main body 5a of the center pole 5, and the bobbin 12 surrounds around the main body 5a of the center pole 5. In other words, the coil 13 is arranged to face the inner peripheral face of the yoke 8 and the bobbin 12 surrounds around the main body 5a of the center pole 5 such that the inner peripheral face of the bobbin 12 is substantially parallel to the outer peripheral face 5d of the main body 5a of the center pole 5. Therefore, the inner peripheral face of the yoke 8 is located in proximity to the coil 13 and the inner peripheral face of the bobbin 12 is located in proximity to the outer peripheral face 5d of the main body 5a of the center pole 5. Accordingly, a constant magnetic flux loop is always formed between the magnet 6, the yoke 8 and the center pole 5 in a circular arrow direction shown in FIG. 1. The magnet 6 and the yoke 8 may be appropriately disposed at positions where a constant magnetic flux can be formed between the center pole 5, the magnet 6 and the yoke 8. Therefore, their disposing positions are not limited to this embodiment.

The frame 10 is bonded with an adhesive on the face of the yoke 8 which is exposed on the outer side of the case 9. Further, the frame 10 is bonded with a screw or an adhesive to a housing (not shown) and is grounded. As described above, the voice coil bobbin 4, the center pole 5, the magnets 6, 7, the yoke 8 and the case 9 are supported by the frame 10.

The diaphragms 2, 3 are attached to the bobbin 12. The diaphragm 2 is a thin plate provided with a plurality of bent portions. One end of the diaphragm 2 is bonded to the outer peripheral face of the bobbin 12 and the other end of the diaphragm 2 is bonded to the frame 10 with an adhesive. The diaphragm 3 is a so-called cone paper. One end of the diaphragm 3 is connected with the outer peripheral face of the bobbin 12 and the other end of the diaphragm 3 is connected with the frame 10 through a joint 14. A center cap 15 is made of aluminum or the like and comprises a main body part which is formed in a dome shape and a flange part which is formed along the outer circumferential edge of the main body part. The flange part of the center cap 15 is bonded to the diaphragm 3 with an adhesive. Therefore, the opening 12b of the bobbin 12 is covered by the center cap 15.

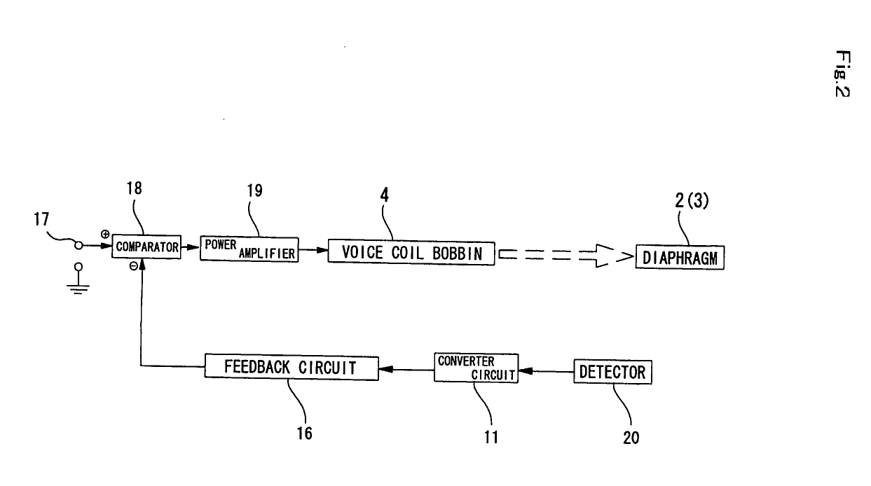

The converter circuit 11 is provided at the tip end of the main body 5a of the center pole 5. The converter circuit 11 is formed on a printed circuit board and the printed circuit board is fixed on the main body 5a of the center pole 5 with an adhesive. Therefore, the converter circuit 11 and the center pole 5 are integrated with each other. Further, a lead wire 11b in which the plus side terminal 11a for output of the converter circuit 11 is formed at its tip end is inserted into a through-hole 5c from the tip end side of the center pole 5 and drawn out on the base end side of the center pole 5 to be connected to a feedback circuit 16 (see FIG. 2). The minus side terminal 11c of the converter circuit 11 is connected to the center pole 5 through the lead wire 11d and is grounded.

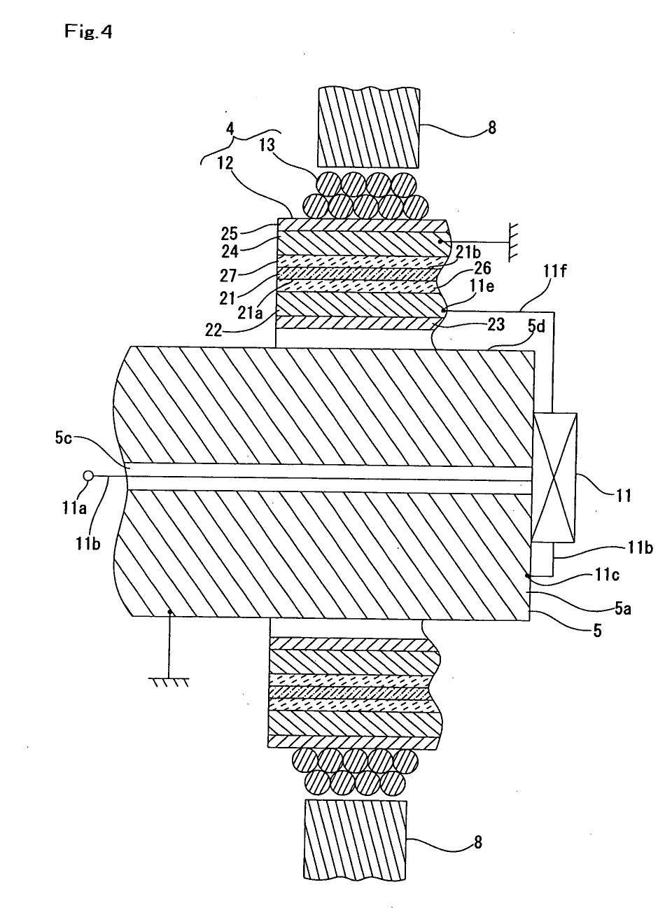

As shown in FIG. 2, an electric signal showing audio information (hereinafter, referred to as an “audio signal”) that is inputted into an input terminal 17 is inputted to a power amplifier 19 through a comparator 18, which is comprised of a CPU (Central Processing Unit). The audio signal that is amplified through the power amplifier 19 is inputted into the voice coil bobbin 4. In other words, an electric current showing an audio signal flows through the coil 13 of the voice coil bobbin 4 and the voice coil bobbin 4 is vibrated in a forward and backward direction (direction shown by the arrow “A” in FIG. 1) by an exciting operation between the electric current and the magnetic flux which is formed between the center pole 5, the magnet 6 and the yoke 8. As a result, the diaphragms 2, 3 vibrate and a sound or the like is emitted from the speaker 1. Further, a detector 20 is provided in the speaker 1. The detector 20 is structured of a so-called capacitor, which is comprised of an inner side copper foil 22 (see FIG. 4) of the voice coil bobbin 4 and the center pole 5, and an electrostatic capacity is formed with this capacitor.

As shown in FIG. 4, the bobbin 12 includes a pipe body 21, the inner side copper foil 22, an inner side resist 23, an outer side copper foil (electric conductor film) 24 and an outside resist 25. The pipe body 21 is formed from a substantially rectangular sheet (not shown) made of polyimide. Specifically, the pipe body 21, which serves as a base of the voice coil bobbin 4, is structured by forming the sheet into a cylindrical shape. The inner side copper foil 22 is bonded to the inner peripheral face 21a of the pipe body 21 with an adhesive 26. A plus side terminal 11e for input of the converter circuit 11 is connected with the inner side copper foil 22 and thus the inner side copper foil 22 and the converter circuit 11 are electrically connected with each other through a lead wire 11f. Further, the inner side resist 23 made of rubber is coated on the inner side copper foil 22 in a film-shaped manner. Therefore, the relative permittivity of the capacitor that is comprised of the inner side copper foil 22 and the center pole 5 is increased, and the electrostatic capacity of the capacitor increases.

The outer side copper foil 24 is bonded to the outer peripheral face 21b of the pipe body 21 with an adhesive 27, and the outer side copper foil 24 is connected to the above-mentioned housing (not shown) and grounded. Further, the outer side resist 25 made of rubber is coated on the outer side copper foil 24 in a film-shaped manner and thus the coil 13 and the outer side copper foil 24 are electrically insulated from each other.

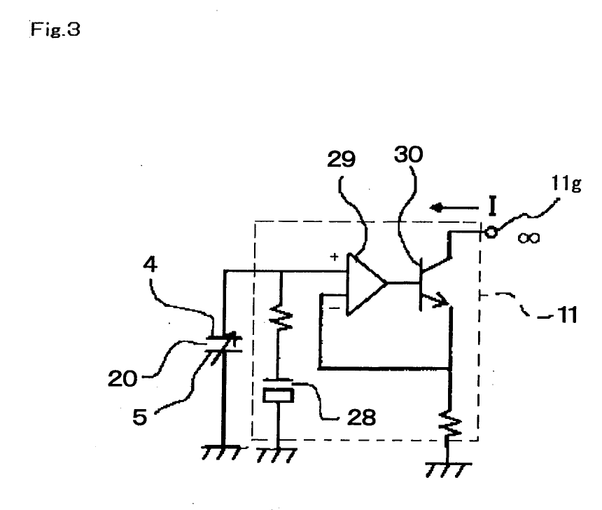

As shown in FIG. 2, the converter circuit 11 converts the electrostatic capacity which is detected with the detector 20 into an electric signal (hereinafter, referred to as “detection signal”) to be outputted. As shown in FIG. 3, the converter circuit 11 comprises a power source 28, an operational amplifier 29 and a transistor 30. The non-inverting input terminal of the operational amplifier 29 and the inner side copper foil 22 of the voice coil bobbin 4 are connected to each other through the lead wire 11f (see FIG. 1). A bias voltage is applied to the inner side copper foil 22 and the non-inverting input terminal of the operational amplifier 29 by the power source 28. The output terminal of the operational amplifier 29 is connected to the input terminal of the transistor 30 and thus the signal that is outputted from the operational amplifier 29 is inputted to the input terminal of the transistor 30. Further, the emitter of the transistor 30, which is its minus side output terminal, is connected to the inverting input terminal of the operational amplifier 29. The connecting point of the emitter of the transistor 30 with the inverting input terminal of the operational amplifier 29 is connected to the minus side terminal 11c (see FIG. 1) through the lead wire 11d. The minus side terminal 11c is connected to the center pole 5 and thus the emitter which is the output terminal on the minus side of the transistor 30 and the inverting input terminal of the operational amplifier 29 are grounded.

An electric signal showing an electrostatic capacity that is formed with the capacitor of the detector 20 is inputted to the non-inverting input terminal of the operational amplifier 29 of the converter circuit 11. In this manner, an electric signal which is inputted from the detector 20 is C-V (electrostatic capacity-voltage) converted and amplified by the operational amplifier 29 and the transistor 30 to be inputted from a terminal 11g to the comparator 18 through the feedback circuit 16 as a detection signal (electric signal) (see FIG. 2). The feedback circuit 16 comprises an integration circuit (not shown), a buffer amplifier (not shown), an electronic volume (not shown), an adding circuit (not shown) and the like.

The comparator 18 compares an audio signal inputted from the input terminal 17 with a detection signal which is inputted from the converter circuit 11 through the feedback circuit 16 in response to the detection signal. The result of the comparison is obtained. In other words, the output level of the audio signal is compared with the output level of the detection signal to calculate the difference. Next, the power amplifier 19 regulates the output level of the audio signal on the basis of the calculated result to input the audio signal into the voice coil bobbin 4.

As described above, according to the speaker 1 which is structured as shown in FIGS. 1 through 4, when an audio signal is inputted into the input terminal 17, the voice coil bobbin 4 vibrates on the basis of the audio signal causing the diaphragms 2, 3 to vibrate with the vibration of the voice coil bobbin 4. The speaker 1 emits a sound or the like on the basis of the vibration of the diaphragms 2, 3. The operating state of the diaphragms 2, 3 at this time is recognized by the detection of the electrostatic capacity with the detector 20. In other words, a facing area between the inner side copper foil 22 of the voice coil bobbin 4 and the outer peripheral face 5d of the main body 5a of the center pole 5 is varied and thus the electrostatic capacity formed between the inner side copper foil 22 and the outer peripheral face 5d of the main body 5a varies. The variation of the electrostatic capacity corresponds to the displacement of the diaphragms 2 and 3. An electric signal indicating the electrostatic capacity that is detected with the detector 20 is inputted to the converter circuit 11 through the lead wire 11f. The electric signal indicating the electrostatic capacity is converted into a detection signal with the converter circuit 11 and inputted into the feedback circuit 16 through the lead wire 11b.

In accordance with an embodiment, since the converter circuit 11 is provided on the tip end of the center pole 5a, the length of the lead wire 11f connecting the detector 20 with the converter circuit 11 can be shortened and thus disturbance noise affecting the lead wire 11f can be reduced. In other words, the electrostatic capacity detected with the detector 20 can be accurately inputted into the converter circuit 11. Further, since disturbance noise is shielded by the outer side copper foil 24 of the voice coil bobbin 4, effect of the disturbance noise applied to the lead wire 11f and the converter circuit 11 can be further suppressed and thus the electrostatic capacity detected with the detector 20 can be further accurately converted into a detection signal. Further, since the lead wire 11b connecting the converter circuit 11 to the feedback circuit 16 is passed through the through-hole 5c, the lead wire 11 can be shielded from disturbance noise by the center pole 5 and thus the detection signal converted by the converter circuit 11 can be accurately inputted into the feedback circuit 16. Further, since the minus side terminal 11c of the converter circuit 11 is grounded, floating electrostatic capacity which is present in the converter circuit 11 can be suppressed and disturbance noise can be reduced. Therefore, the electrostatic capacity obtained from the detector 20 can be further accurately converted into a detection signal. Further, the lead wire 11f and the converter circuit 11 are surrounded by members having a shielding function such as the center cap 15, the outer side copper foil 24 and the center pole 5. Therefore, effects of disturbance noise with respect to the lead wire 11f and the converter circuit 11 can be further suppressed.

The present invention has been described in detail using the embodiments, but the present invention is not limited to the embodiments described above and many modifications can be made without departing from the present invention. In the embodiment described above, the converter circuit 11 is mounted on the tip end of the main body 5a of the center pole 5. However, the converter circuit 11 may be mounted on a support member which supports at least one of the center pole 5 and the voice coil bobbin 4 and, for example, the converter circuit 11 may be mounted on the case 9 or the frame 10. In this case, it is preferable that the magnitude of the electrostatic capacity formed between the voice coil bobbin 4 and the center pole 5 is set to be not affected by disturbance noise. In other words, the level of the electrostatic capacity formed between the voice coil bobbin 4 and the center pole 5 is preferably set so as not to be affected by disturbance noise while an electric signal showing the electrostatic capacity is inputted into the converter circuit 11. In this manner, even when the converter circuit 11 is mounted on the case 9 or the frame 10, the lead wire connecting the converter circuit 11 with the detector 20 can be shortened and thus the size of the speaker can be reduced.

Further, the converter circuit 11 may be mounted on the diaphragm 2 or the diaphragm 3. Also in this case, it is preferable that the magnitude of the electrostatic capacity formed between the voice coil bobbin 4 and the center pole 5 is set to be not affected by disturbance noise. In this manner, even when the converter circuit 11 is mounted on the diaphragm 2 or the diaphragm 3, the lead wire connecting the converter circuit 11 with the detector 20 can be shortened and thus the size of the speaker can be reduced.

In the embodiment described above, in order that the minus side terminal 11c of the converter circuit 11 is grounded, the minus side terminal 11c is connected to the center pole 5. However, the present invention is not limited to this embodiment and the minus side terminal 11c may be connected to the case 9 or the frame 10 which is grounded.

In the embodiment described above, the inner side copper foil 22 is bonded to the inner peripheral face 21a of the pipe body 21 with the adhesive 26 and the outer side copper foil 24 is bonded to the outer peripheral face 21b of the pipe body 21 with the adhesive 27. However, a copper film may be formed on each of the inner peripheral face 21a and the outer peripheral face 21b of the pipe body 21 by evaporating copper. Other appropriate methods for forming a copper film may be utilized.

In the embodiment described above, the inner side resist 23 is formed on the inner side copper foil 22 and the outer side resist 25 is formed on the outer side copper foil 4 by using a coating process. However, the inner side resist and the outer side resist which are formed in a thin film shape may be bonded to the inner side copper foil 22 and the outer side copper foil 4 with an adhesive. As described above, each resist may be formed in a film-like shape and a method for forming the resist may be changed appropriately.

In the embodiment described above, copper films are formed on the inner peripheral face 21a and the outer peripheral face 21b of the pipe body 21. However, the present invention is not limited to this embodiment. For example, a film may be formed of aluminum or plastic having electro-conductivity, and the inner peripheral face 21a and the outer peripheral face 21b of the pipe body 21 may be provided with a nonmagnetic and electric conductor film.

In the embodiment described above, the pipe body 21 is made of polyimide but its material is not limited to polyimide. For example, the pipe body 21 may be made of paper or another appropriate insulator may be utilized as the pipe body 21.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A speaker comprising:
a center pole;
a voice coil bobbin;
a support member which supports at least one of the center pole and the voice coil bobbin; and
a converter circuit for converting an electrostatic capacity which is formed between the center pole and the voice coil bobbin into an electric signal to be outputted;
wherein the converter circuit is provided on either of the support member and the center pole.

2. The speaker according to claim 1, wherein the converter circuit is disposed at a tip end of the center pole.

3. The speaker according to claim 2, wherein the voice coil bobbin is structured with a nonmetallic pipe body as a base and a nonmagnetic electric conductor film is formed on an outer peripheral face of the pipe body.

4. The speaker according to claim 3, wherein the nonmagnetic electric conductor film is grounded.

5. The speaker according to claim 2, wherein
the voice coil bobbin is structured with a nonmetallic pipe body as a base,
an electric conductor film for forming a capacitor between the center pole and the electric conductor film is formed on an inner side of the pipe body, and
an electrostatic capacity of the capacitor is detected by the converter circuit which is disposed at the tip end of the center pole.

6. The speaker according to claim 5, wherein an electric conductor film which is grounded is formed on an outer side of the pipe body.

7. The speaker according to claim 5, wherein a through-hole is formed from the tip end of the center pole to a base end of the center pole and a lead wire for outputting an electric signal which is outputted from the converter circuit is passed through the through-hole.

8. The speaker according to claim 1, wherein a through-hole is formed from a tip end of the center pole to a base end of the center pole and a lead wire for outputting an electric signal which is outputted from the converter circuit is passed through the through-hole.

9. The speaker according to claim 1, wherein a minus side terminal of the converter circuit is grounded.

10. A speaker comprising:
a center pole;
a voice coil bobbin;
a diaphragm and
a converter circuit for converting an electrostatic capacity, which is formed between the center pole and the voice coil bobbin, into an electric signal to be outputted is provided on the diaphragm.
